(19) United States
(12) Patent Application Publication
(10) Pub. No.: US 2006/0012777 A1
(43) Pub. Date: Jan. 19, 2006

(54) Combination laser system and global navigation satellite system

(76) Inventors: Nicholas C. Talbot, Ashburton (AU); Mark E. Nichols, Christchurch (NZ); Gary L. Cain, Springfield, OH (US); James M. Janky, Los Altos, CA (US)

Correspondence Address: DINSMORE & SHOHL LLP;One Dayton Centre, Suite 1300, One South Main Street, Dayton, OH, 45402-2023, US

(21) Appl. No.: 10/890,037

(22) Filed: Jul. 13, 2004

(51) Int. Cl. G01C 1/00; G01B 11/26; G01S 1/00; H04B 7/185

(52) U.S. Cl. 356/139.01

(57) ABSTRACT

A combination laser system and global navigation satellite system has a laser detector positioned in a known and fixed relationship with the nominal phase center of an included global navigation satellite antenna. The outputs of the laser system and the global navigation satellite system are used together to determine position.

### BACKGROUND OF THE INVENTION

The current invention relates to position tracking and machine control systems, and in particular to a combination of laser systems and global navigation satellite systems to track position and to provide accurate machine control.

Global navigation satellite systems, like GPS, and GLONASS have been used extensively to determine position coordinates, facilitating surveying and automated control of mobile units. In the future, the European GALILEO system will have similar capabilities. An autonomous navigational system that includes a satellite receiver and a navigational computer can achieve a 10-meter level of accuracy in determining the position of a mobile unit using solely the satellite signals. Differential navigational systems that utilize differential corrections in addition to the satellite signals can determine the positional information to within a meter range of accuracy. Real-time kinematic (RTK) navigational systems that are capable of utilizing both code and carrier information transmitted from such satellites can achieve centimeter level accuracy.

However, a level of accuracy less than a centimeter has been beyond the reach of typical satellite-based navigational systems. In an attempt to achieve very high accuracy, prior art systems have included rotating laser transmitters that project a plane of light to millimeter level accuracy. However, these prior art laser-based systems cannot be used for the purposes of three dimensional navigation of mobile objects because they are configured to determine only the vertical coordinate with great accuracy.

### SUMMARY OF THE INVENTION

It is against the above mentioned background, that the present invention provides a number of unobvious advantages and advances over the prior art. In particular, the present invention discloses a combination laser system and global navigation satellite system that allows a user to realize high precision control of mobile units, including high precision machine control.

With the combination laser detector and global navigation satellite antenna, the laser height reference detected by the laser detector is provided in a known and fixed relationship with the nominal phase center of the global navigation satellite antenna. Each mobile unit equipped with a combination laser detector and global navigation satellite antenna uses the data from both the laser system and the GPS system to improve its position determination capabilities. The signals received from said laser detector are used to facilitate the determination of the position of the mobile unit based on the signals from the global navigation satellite antenna.

### BRIEF DESCRIPTION OF THE DRAWINGS

The aforementioned advantages of the present invention, as well as additional advantages thereof, will be more clearly understood hereinafter as a result of a detailed description of a preferred embodiment of the invention when taken in conjunction with the following drawings, wherein like elements are indicated by like symbols.

FIG. 1 shows a position tracking and control (PTC) system according to one embodiment of the present invention wherein the PTC system comprises a laser system, one or more mobile units, each having a combination laser detector and global navigation satellite (CLDGNS) antenna and an associated control system, and a communication link.

FIGS. 2-4 depict various embodiments of combination laser detector and global navigation satellite antennas according to the present invention.

FIGS. 5-7 are schematic diagrams useful in explaining the manner in which data from the laser system and data from the global navigation satellite system are combined.

### DETAILED DESCRIPTION OF THE VARIOUS EMBODIMENTS

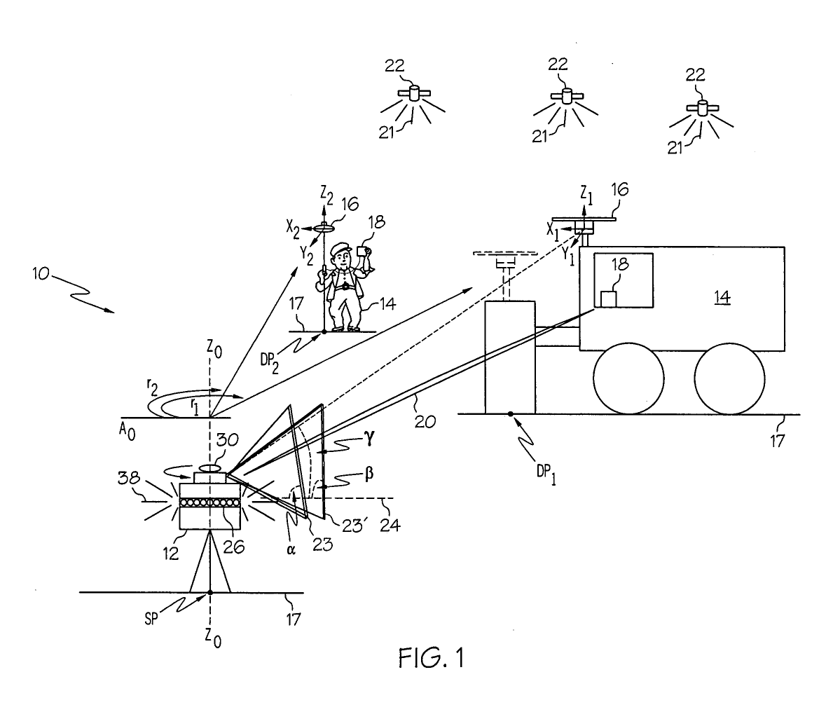

The present invention can be best understood by focusing on FIG. 1 which depicts a position tracking and control (PTC) system 10. The PTC system 10 comprises a laser transmitter system 12, one or more mobile or rover units 14, each having a combination laser detector and global navigation satellite (CLDGNS) antenna 16 and an associated control system 18, and having a transmitter for establishing a communication link 20, preferably a radio link. Signals 21 from a plurality of global navigation satellites 22 orbiting the earth, such as GPS, GLONASS, GALILEO, and combinations thereof, are received by the CLDGNS antenna 16 so that the coordinates of dynamic points in a plot of land 17, such as points indicated as DP₁ and DP₂, can be determined to a centimeter level of accuracy by the control system 18. Control system 18 includes a microprocessor or other computing hardware configured to process data from the antenna 16 to provide an estimate of the position of the antenna 16.

Millimeter level of accuracy in determining the position of the dynamic points DP₁ and DP₂ relative to each CLDGNS antenna 16 is provided by the control system 18 which uses information provided by the laser system 12 in its coordinate (x, y, z) position computation in addition to signals received from satellites 22. In one embodiment, the laser system 12 provides at least two diverging or fan-shaped beams 23 and 23′ that rotate continuously about a vertical axis Z₀ at a uniform rate above a known stationary point SP in the plot of land 17. The fan-shaped beams 23 and 23′ project from the laser system 12 in non-vertical planes, such that the first fan beam 23 will intersect an arbitrary horizontal reference plane 24 at an angle α, and the second fan shaped beam 23′ will intersect the horizontal reference plane at an angle β. Dynamic point DP₁, may be a working element on a machine, such as a grader blade, while dynamic point DP₂ may be a point at the bottom of a manually positioned mast being moved about by a surveyor.

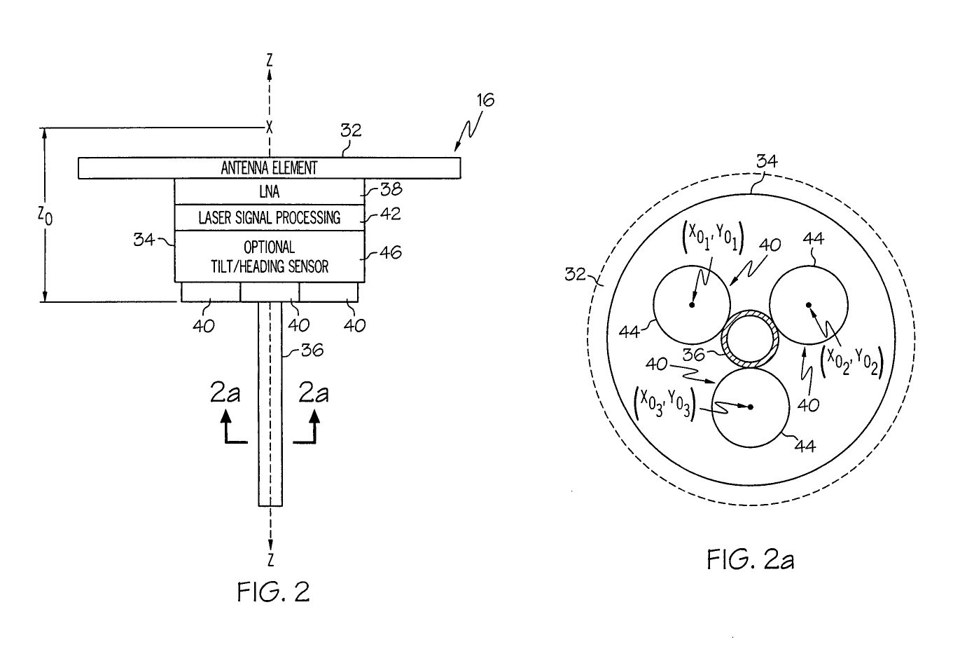

It is to be appreciated that the fan-shaped beams 23 and 23′, if rotated at a constant speed about a vertical axis, will activate one after another (with some delay of time therebetween) at least one optical sensor 44 (FIGS. 2-4) of each CLDGNS antenna 16. Further, it is to be appreciated that in the embodiment of FIG. 1, the time delay between activating the optical sensor 44 by each fan-shaped beam 23 and 23′ will increase or decrease as the relative position of a CLDGNS antenna 16 moves above or below the horizontal reference plane 24, respectively. It is to be appreciated that the CLDGNS antenna 16 can be initialized to any arbitrary horizontal reference plane 24 simply by selecting and entering into the control system 18 a detection time delay. Additionally, it is to be appreciated that any detected change by the CLDGNS antenna 16 in the detection time delay is related to an angle γ, which is the angle at which a straight line passing through the optical sensor 44 (FIGS. 2-4) of the CLDGNS antenna 16 and the point of emanation of the fan-shaped beams 23 and 23′ meets the selected arbitrary horizontal reference plane 24.

As mentioned above, angles α and β are constants. Angle γ is determined by sensing the timing between the illumination of the sensor 44 by the beams 23 and 23′. The higher the sensor 44, the greater the delay. It will be apparent that fluctuation in the rotation speed of the fan-shaped beams 23 and 23′ will introduce short term, transient errors. To minimize such errors, the control processor 18 may be provided with the rotation speed of the laser system 12 via the communication link 20. The rotation speed may, however, be phase locked to a crystal oscillator, providing sufficient accuracy. Accordingly, knowing the rotation speed, the control system 18 can compute the value of angle y arithmetically from the detected time delay between illumination by the beams 23 and 23′, and thus the elevation angle of the optical sensor in the CLDGNS antenna 16 above the reference horizontal plane 24 is determined.

In another embodiment, the laser system 12 is further provided with a plurality of light sources which are strobed at the same point in time during each rotation of the beams 23 and 23′. Beacon 26 provides a simultaneous 360° flash 38 at a different wavelength than the fan shaped beams 23 and 23′. By orientating the laser system 12 such that the beacon 26 flashes as the mid point between the fan-shaped beams 23 and 23′ passes a known true heading A₀, the control system 18 can also compute a relative bearing to the laser system 12 from the time delay between detecting the signal 38 of the beacon and detecting the fan-shaped beams 23 and 23′.

In still another embodiment, the laser system 12 is provided with a global navigation satellite system (GNSS) receiver 30. The GNSS receiver 30 can receive and compute its position from the signals 21 provided by the global navigation satellites 22. A detailed discussion of how to determine a location from such signals is disclosed by U.S. Pat. No. 6,433,866, also assigned to Trimble Navigation, LTD, the disclosure of which is herein incorporated fully by reference.

The control system 18 in addition to knowing its own position (as computed from the detected satellite signals received and provided by the CLDGNS antenna 16), is provided also with the known and fixed position of the laser system 12 via the communication link 20. Using the information provided by the laser system 12 for correlation and error correcting, the control system 18 can then compute the coordinate (x, y, z) position of any dynamic point relative to the CLDGNS antenna 16 to a high degree of accuracy. A more detail discussion of the computations performed by the control system 18 is disclosed below.

It is to be appreciated that the PTC system 10 provides a number of benefits to a potential mobile user by integrating a laser detector and a global navigation satellite antenna. For example, the CLDGNS antenna 16 costs less than separate laser detectors and global navigation satellite antennas because the integrated CLDGNS antenna requires only one set of packaging, and can utilize shared circuitry and wiring, computer memory and processing, and a common power supply. Other benefits are disclosed with reference made to FIGS. 2-4 which illustrate various embodiments of the combination laser detector and global navigation satellite antenna according to the present invention.

FIG. 2 illustrates diagrammatically one embodiment of a CLDGNS antenna 16 which provides an antenna element 32 mounted to an electronic housing 34, which in turn is mounted to an end of an elongated support 36, such as a mast. Within the housing 34, the antenna element 32 is coupled to a low noise amplifier (LNA) 38, and a laser detector 40 is coupled to a laser signal processor 42. The laser detector 40 may include a number of optical sensors 44 placed around the periphery of the housing 34. The optical sensors 44 face generally downward and outward. In this orientation, at least one of the optical sensors 44 will detect the fan-shaped beams 23 and 23′ from the laser system 12, and two or more optical sensors 44 will detect the fan-shaped beam some of the time. Each optical sensor 44 can be read independently and its position calculated by the control system 18.

In the illustrated embodiment of FIG. 2, three optical sensors 44 are provided, and in other embodiments more may be included to improve laser detection, if desired. In such embodiments, with the relative positions X₀, Y₀, and Z₀ of each optical sensor 44 to the nominal phase center x of its respective antenna element 32 being known, transposing the detected laser position of each optical sensor 44 to the nominal phase center x of the antenna element 32 is easily computed arithmetically by the control system 18.

The difference in the detected elevation between at the three optical sensors 44 provides an indication of tilt, which in turn may be used by the control system 18 to compensate for errors that would otherwise result in the calculated position of DP₁ and DP₂. Additionally, although the antenna tilt angle is important for adjusting the detected laser heights of each optical sensor 44 to the nominal phase center x of the associated antenna element 32, these changes in detected laser heights can also be used to help determine the orientation of the device (such as a grader/bulldozer blade) to which the CLDGNS antenna 16 may be connected. However, if desired, a tilt/heading sensor 46 may be further included in the packaging of the CLDGNS antenna 16 to simplify further the compensation for tilt, error correcting, and device orientation determination.

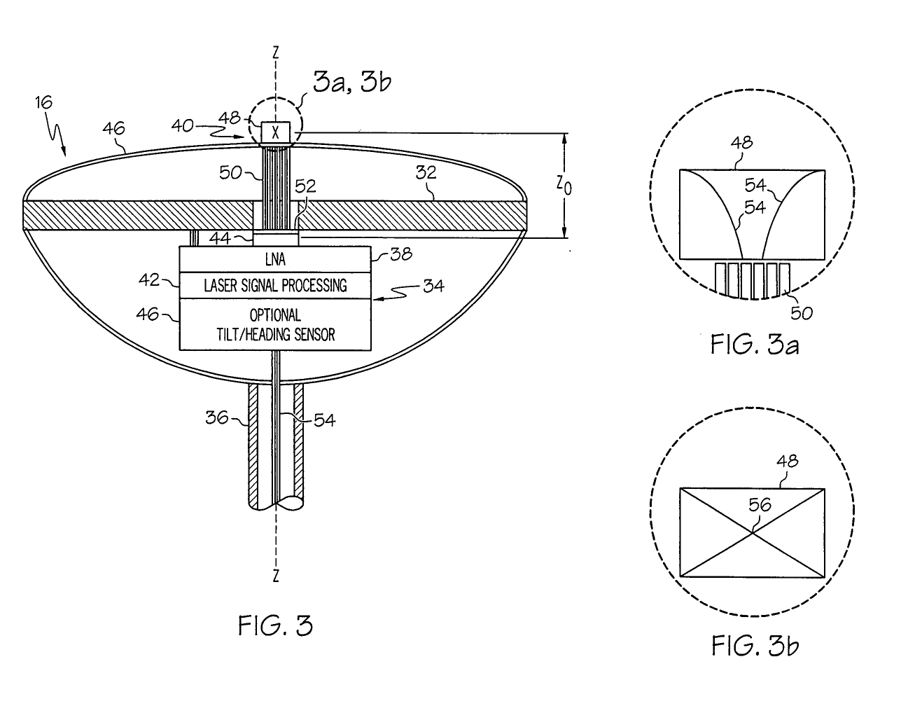

In another embodiment of the CLDGNS antenna 16, illustrated by FIG. 3, the electronic housing 34 and the antenna element 32 are protected by a radome 46. A fiber optic pick-up 48 of the laser detector is positioned on the top of the radome 46. The fiber-optic pick-up 48 is small, about 0.25 inches (6 mm) in diameter, as it only needs to collect enough energy to activate the optical sensor 44. The non-metallic fiber optic pick-up 48 is orientated along the Z axis, aligned vertically with the nominal phase center x of the antenna element 32. The laser detector also includes optical fiber 50 coupling the fiber optic pick-up 48 to the optical sensor 44. In this embodiment, the optical sensor 44 is positioned below the antenna element 32. A filter 52 may be optionally provided to filter out light noise received by the fiber optic pick-up 48. This improves the sensitivity of the optical sensor 44 to the energy of the fan-shaped beams 23 and 23′ (FIG. 1).

In one embodiment, the fiber optic pick-up 48 comprises a circularly symmetric hyperbolic mirrored surface 54 (FIG. 3a) that catches light from 360 degrees, and reflects it to the optical sensor 44, via the optical fibers 50. In another embodiment, the fiber optic pick-up 48 may comprises a TIR prism 56 (FIG. 3b) which redirects the laser energy to the optical sensor 44, via optical fiber 50. The use of a total internal reflection (TIR) prism 56 requires no metallic coatings to ensure reflectivity, thereby removing all metal from above the antenna element 32. Since the metallic and semi-metallic portions of the optical sensor 44 are located below the antenna element 32, they will not adversely affect the ability of the antenna 16 to pick up the relatively weak satellite signals 21. Cabling 58 is provided through the support 36 to connect the output of the CLDGNS antenna 16 to the control system 18 (FIG. 1).

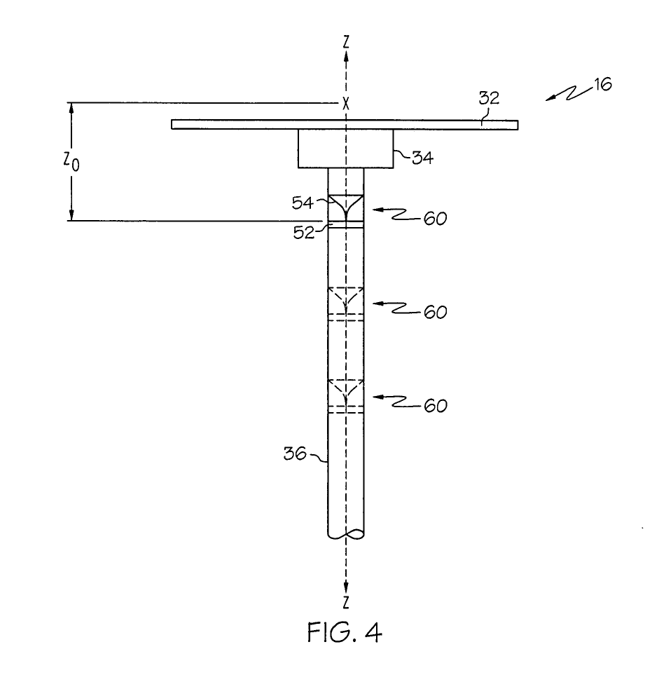

In yet another embodiment, illustrated by FIG. 4, one or more sensors 60 are located below the electronics housing 34, spaced along the support 36. This arrangement for the sensors 60 has the advantage of not interfering with reception, and also of not affecting the location of the nominal phase center x of the antenna element 32. Each sensor 60 may comprise a circularly symmetric hyperbolic mirrored surface or a prism. Because each sensor 60 is below the antenna element 32, fiber optics may not be required since the sensors may be integrated closely with the detectors. A filter 52 may be provided to filter out extraneous energy to improve sensitivity to laser light. The output signals from the detectors in all the above disclosed embodiments are coupled to associated processors 42. The output of processor 42 is included in the output of the CLDGNS antenna 16 and provided to the control system 18 for further use and evaluation.

In the embodiment of FIG. 4, the sensors 60 may be provided at known positions along the support 36. Information provided by the sensors 60 can be used by the control system 18 to determine the distance from the transmitter 12 to the sensors 60. Since computation is well known to those skilled in the art, no further discussion is provided. This co-axial alignment simplifies implementation though non-co-axial implementations are also possible.

In the above disclosed embodiments of the CLDGNS antenna 16 (FIGS. 1-4), each of the laser detectors and the nominal phase center x of the antenna element are separated by a known, fixed distance and are generally aligned co-axially. In particular, the Z₀ distance (and the X₀, Y₀ distances, if necessary) of each optical sensor 44 relative to the nominal phase center x of the antenna element 32 are factory set. Accordingly, the CLDGNS antenna 16 improves the accuracy of the PTC system 10 by preventing an operator from manually entering a positional error into control system 18 due to a miscalculated measurement between the optical sensors of the laser detector and the nominal phase center x of the antenna element.

In the above embodiments, the CLDGNS antenna 16 is illustrated as having either a geodesic shape or a generally flat disc shape. However, it is to be appreciated that other satellite antennas may also be used advantageously with the concepts of the present invention.

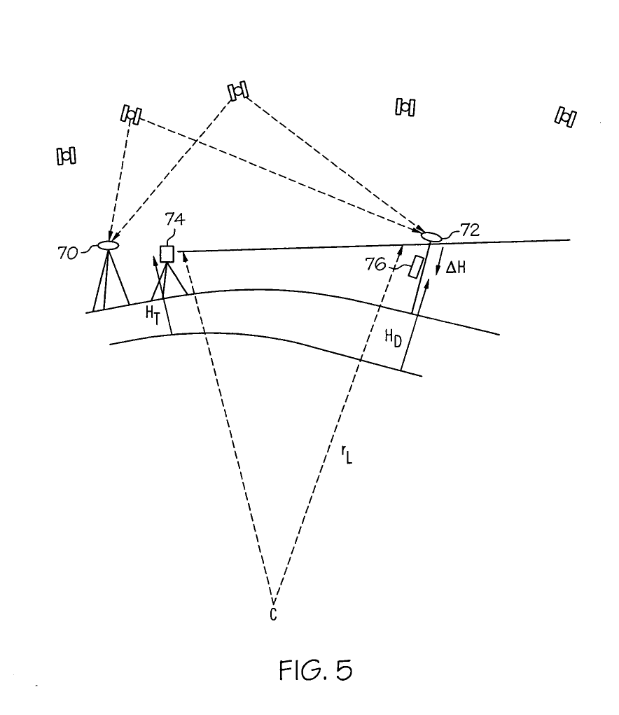

Reference is made to FIG. 5 which illustrates a GNSS and laser system. A base GNSS receiver 70 is located at a known mark and tracks the satellites in view. Range and/or carrier phase measurements are taken by the base receiver 70 and transmitted to the mobile or rover GNSS receiver 72. The mobile GNSS receiver 72 tracks two or more GNSS satellites that are also tracked by the base receiver 70. Alternatively, a network of base GNSS receivers can be used to generate a data stream that is largely corrected for atmospheric and satellite error sources. This approach is termed Network Real-Time Kinematic positioning and has position accuracy advantages over systems that use a single base receiver.

A laser transmitter 74 is located on site and provides suitable coverage for the laser detector 76. The elevation of the laser transmitter 70 relative to the same datum as the GNSS is known. In the case of GPS, the reference spheroid is the World Geodetic System 1984. The laser detector 76 senses the signals sent from the transmitter 74 and determines the difference in elevation relative to the transmitter 74. The laser transmitter aligns itself with the instantaneous direction of gravity and will not in general accord with the direction of a normal to the spheroid at the same point. Fortunately, the reference spheroid sufficiently well approximates the physical earth (mean sea level), particularly given that the operating range of the laser is less than 500 meters. As a result, the height difference obtained from the laser system, will be compatible with changes in height determined from the GNSS.

Let r₁, r₂, . . rₛ be the range observations from the mobile GNSS antenna to satellites 1, 2, . . s. Observations from the base GNSS system are used to correct the mobile observations. The range observations can be considered as either code, or phase. In the case of phase, it is assumed that the carrier phase ambiguities have been removed.

The satellite coordinates are known and are obtained via an ephemeris, typically broadcast by each satellite. The satellite coordinates are given in terms of WGS84 XYZ Cartesian form (i.e., Xᵢ, Yᵢ, Zᵢ, where i=1, 2 . . s).

Laser height readings taken at the mobile detector 76 provide the difference in elevation (ΔH) to the Laser Transmitter. This height difference must then be applied to the height of the Laser transmitter above the reference spheroid (H_{T}) to obtain the height of the laser detector 76 above the spheroid (H_{D}). The distance from the center of the spheroid to laser detector 76 is computed by adding H_{T} to the radius of curvature of spheroid at the mobile unit. Finally, the distance from the center of the spheroid to the GNSS antenna is generated by applying any height offset between laser detector 76 and antenna for the receiver 72—the final range measurement (r_{L}) is compatible with those obtained from GNSS. Hence, the laser height input can be considered as an additional satellite observation, with the satellite located at the center of the earth.

We next apply least squares estimation to estimate the X, Y, and Z coordinates of the mobile unit (plus the receiver clock bias term T). The observation equations needed for the process are common to both GNSS and laser data and can be presented in linearised form as:
lᵢ+vᵢ=Ax (1)
where:
lᵢ is a vector of observation minus computed terms for each satellite (i=1, 2 . . s) and the laser-detector (i=L). The approximate coordinates of the rover (X₀, Y₀, Z₀) are used to form the computed (theoretical) range values, Rᵢ;
vᵢ is a vector of observation residuals that recognize that the observations are not perfect, but are affected by small errors;
A is a design matrix that relates the observations with the unknowns; and
x is a vector of corrections to the approximate rover antenna coordinates and the approximate GNSS receiver clock bias term (T₀).

The components of equation (1) are presented in full matrix form below:

$$[ \begin{matrix}{r}_{1} - {R}_{1} \\ {r}_{2} - {R}_{2} \\ ⋯ \\ {r}_{s} - {R}_{s} \\ {r}_{L} - {R}_{L}\end{matrix} ] + [ \begin{matrix}{v}_{1} \\ {v}_{2} \\ ⋯ \\ {v}_{s} \\ {v}_{L}\end{matrix} ] = [ \begin{matrix}{a}_{1} & {b}_{1} & {c}_{1} & 1 \\ {a}_{2} & {b}_{2} & {c}_{2} & 1 \\ ⋯ & ⋯ & ⋯ & ⋯ \\ {a}_{s} & {b}_{s} & {c}_{s} & 1 \\ {a}_{L} & {b}_{L} & {c}_{L} & 0\end{matrix} ] [ \begin{matrix}Δ X \\ Δ Y \\ Δ Z \\ Δ T\end{matrix} ] \qquad ( 2 )$$

The design matrix terms aᵢ, bᵢ, cᵢ are the direction cosines for the range observations from the rover antenna 72 to satellites (for GNSS observations) and from the rover antenna 72 to the center of the spheroid (for laser observations). The direction cosines are computed using:

$${a}_{i} = - \frac{( {X}_{i} - {X}_{0} )}{{R}_{i}} ; {b}_{i} = \frac{- ( {Y}_{i} - {Y}_{0} )}{{R}_{i}} ; {c}_{i} = \frac{- ( {Z}_{i} - {Z}_{0} )}{{R}_{i}} ; \qquad ( 3 )$$

Each observation presented in equation (1) has an associated uncertainty. In the case of the GNSS phase observations, this is normally on the order of a centimeter. In the case of laser height readings, it is on the order of a few millimeters. Hence, an observation weight matrix is introduced that is formed by the inverse of the individual observation variances:

$$P = [ \begin{matrix}{p}_{1} & 0 & ⋯ & 0 & 0 \\ 0 & {p}_{2} & ⋯ & 0 & 0 \\ ⋯ & ⋯ & ⋯ & ⋯ & ⋯ \\ 0 & 0 & & {p}_{s} & 0 \\ 0 & 0 & & 0 & {p}_{L}\end{matrix} ] \qquad ( 4 )$$

Based on the principle of least squares, the most-probable value of the corrections to the unknowns are obtained by minimizing the sum of the squares of the weighted observation residuals according to:
x=(A^{T}PA)⁻¹(A^{T}Pl) (5)

Finally, the corrected coordinates and clock bias term (denoted with a superscript ˆ) of the rover are obtained by applying the result of equation (5) to the respective approximate values used as the linerization point for the adjustment:

$$[ \begin{matrix}\hat{X} \\ \hat{Y} \\ \hat{Z} \\ \hat{T}\end{matrix} ] = [ \begin{matrix}{X}_{0} \\ {Y}_{0} \\ {Z}_{0} \\ {T}_{0}\end{matrix} ] + [ \begin{matrix}Δ X \\ Δ Y \\ Δ Z \\ Δ T\end{matrix} ] \qquad ( 6 )$$

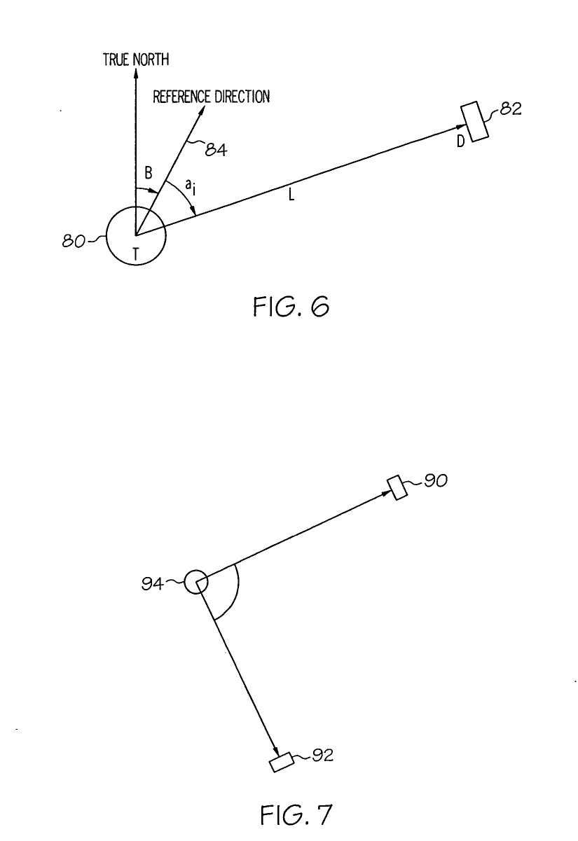

The laser system may include the facility to form measurements of horizontal angles referenced to a fixed direction such as north. Reference is made to FIG. 6. Every time the rotating laser passes a reference mark, a unidirectional bank of LEDs are illuminated at the laser transmitter 80. At the laser detector 82, the time between the next laser strike and the LED illumination provides a measure of the angular displacement of the detector from the reference line, given that the rotation rate of the laser transmitter 80 is measured and therefore is known.

In FIG. 6, the laser transmitter 80 is arbitrarily aligned such that there is an angular displacement of the device with respect to true north of B degrees. Readings of the angle between the transmitter reference line 84 and the detector 82 are available on each sweep of the laser and are denoted by aᵢ. The location of the transmitter 80 is given in terms of three dimensional Cartesian coordinates by X_{T}, Y_{T}, and Z_{T}, while the detector coordinates are X, Y, and Z, as before.

The angular readings may be input as positional observations into the overall estimation scheme used in a combined laser/GNSS system. The least squares approach can be once again applied. For simplicity, consider the unknown coordinates of the detector in terms of a horizontal plane centered on the transmitter 80. Let E_{T}, N_{T} be the planar coordinates of the transmitter and E, N, the coordinates of the detector. The observation equation that links the angular observations with the detector coordinates is given below:

$${a}_{i} + {w}_{i} = {tan}^{- 1} ( \frac{E - {E}_{T}}{N - {N}_{T}} ) - B \qquad ( 7 )$$

Each angular observation is subject to a small, random error wᵢ. It is possible that the laser transmitter will be manually aligned to north in the field, in which case B will be identically zero. For the purposes of the discussion, below, it is worthwhile considering B as an unknown parameter that can be determined via the integration of GPS and laser devices.

The three unknown parameters in equation (7) are E, N, and B:
αᵢ=f(E, N, B) (8)

In order to apply the theory of least squares we must linearize the observation equation:

$${a}_{i} = f ( {E}_{0} , {N}_{0} , {B}_{0} ) + \frac{ⅆ f}{ⅆ E} Δ E + \frac{ⅆ f}{ⅆ N} Δ N + \frac{ⅆ f}{ⅆ B} Δ B \qquad ( 9 )$$

where E₀, N₀, and B₀, are initial guesses for the values of E, N and B, respectively; df/dE, df/dN, and df/dB are the partial derivatives of the function with respect to each unknown parameter; and ΔE, ΔN, and ΔB are corrections to the initial estimates E₀, N₀, and B₀, that lead to the most probable values of the unknowns. Written out in matrix form, equation(9) becomes:

$$[ {a}_{i} - {α}_{0} ] + [ {w}_{i} ] = [ \frac{ⅆ f}{ⅆ E} \frac{ⅆ f}{ⅆ N} \frac{ⅆ f}{ⅆ B} ] [ \begin{matrix}Δ E \\ Δ N \\ Δ B\end{matrix} ] \qquad ( 10 )$$

with αₒ the computed angle based on the approximate coordinates of the detector. That is, by inserting E₀ for E, N₀ for N, and B₀ for B in equation (7), we obtain αₒ.

If our initial guess for E, N and B is very good, then αₒ will be very close to the actual observed angle αᵢ.

The partial derivatives of the observation equation with respect to the unknowns are given by:

$$\begin{matrix}\frac{ⅆ f}{ⅆ E} = \frac{( N - {N}_{T} )}{{( E - {E}_{T} )}^{2} + {( N - {N}_{T} )}^{2}} = \frac{( N - {N}_{T} )}{{L}^{2}} & ( 11 ) \\ \frac{ⅆ f}{ⅆ N} = \frac{- ( E - {E}_{T} )}{{L}^{2}} & ( 12 ) \\ \frac{ⅆ f}{ⅆ B} = - 1 & ( 13 )\end{matrix}$$

A single angle observation from a single transmitter is insufficient for determining the location of the detector. With multiple transmitters, the intersection of two angular observations suffices.

Equation (2) shows the matrix form of GNSS and laser observations being used to estimate the unknown coordinates of the detector antenna. Now we wish to integrate the angular observations into the combined solution for the coordinates of the detector and therefore we need to convert the angular observation development from the E, N plane system to X, Y, and Z Cartesian coordinates. The two coordinate systems are related via the following rotation matrix:

$$[ \begin{matrix}E - {E}_{T} \\ N - {N}_{T} \\ U - {U}_{T}\end{matrix} ] = [ \begin{matrix}- sin λ & - cos λ & 0 \\ - sin ϕcos λ & - sin ϕsin λ & cos ϕ \\ cos ϕ cos λ & cos ϕ sin λ & sin ϕ\end{matrix} ] [ \begin{matrix}( X - {X}_{T} ) \\ ( Y - {Y}_{T} ) \\ ( Z - {Z}_{T} )\end{matrix} ] \qquad ( 14 )$$

The rotation matrix contains trigonometric values relating to the latitude (φ), and longitude (λ) of the transmitter. Equation (14) can be used in equation (7) to produce a new angle observation equation that relates to the same coordinate system as that used for GNSS data:

$${a}_{i} + {w}_{i} = {tan}^{- 1} \\ ( \frac{- sin λ ( X - {X}_{T} ) - cos λ ( Y - {Y}_{T} )}{- sin ϕ cos λ ( X - {X}_{T} ) - sin ϕ sin λ ( Y - {Y}_{T} ) + cos ϕ ( Z - {Z}_{T} )} ) - B \qquad ( 15 )$$

In equation (15), the X_{T}, Y_{T}, Z_{T} and φ, λ coordinates of the transmitter are assumed to be known and are a function of: X, Y, Z and B:
αᵢ+wᵢ=g(X, Y, Z, B) (16)

A linearization process is used to produce an observation equation that can be applied in a least squares estimation scheme:

$${a}_{i} + {w}_{i} = g ( {X}_{0} , {Y}_{0} , {Z}_{0} , {B}_{0} ) + \frac{ⅆ g}{ⅆ X} Δ X + \frac{ⅆ g}{ⅆ Y} Δ Y + \frac{ⅆ g}{ⅆ Z} Δ Z + \frac{ⅆ g}{ⅆ B} Δ B \qquad ( 17 )$$

The partial derivatives in equation (17) involving trig functions are straightforward to compute, and are therefore omitted here.

We now have all of the components needed to state the matrix form of the observation equations for combined GNSS, laser height and laser direction data:

$$[ \begin{matrix}{r}_{1} - {R}_{1} \\ {r}_{2} - {R}_{2} \\ {r}_{s} - {R}_{s} . \\ {r}_{L} - {R}_{L} \\ a - α\end{matrix} ] + [ \begin{matrix}{v}_{1} \\ {v}_{2} \\ {v}_{s} \\ {v}_{L} \\ w\end{matrix} ] = [ \begin{matrix}{a}_{1} & {b}_{1} & {c}_{1} & 1 & 0 \\ {a}_{2} & {b}_{2} & {c}_{2} & 1 & 0 \\ {a}_{s} & {b}_{s} & {c}_{s} & 1 & 0 \\ {a}_{L} & {b}_{L} & {c}_{L} & 1 & 0 \\ h & j & k & 0 & - 1\end{matrix} ] [ \begin{matrix}Δ X \\ Δ Y \\ Δ Z \\ Δ T \\ Δ B\end{matrix} ] \qquad ( 18 )$$

where the horizontal direction partial derivatives with respect to X, Y and Z are given by h, j and k, respectively.

An observation weight must be assigned to the angle measurement shown in equation (18). Then, the best estimates of the corrections to the coordinates, GNSS receiver clock, and laser transmitter orientation are obtained using the matrix expression (5). Finally, the best estimates of the parameters are computed by applying the corrections to their approximate values:

$$[ \begin{matrix}\hat{X} \\ \hat{Y} \\ \hat{Z} \\ \hat{T} \\ \hat{B}\end{matrix} ] = [ \begin{matrix}{X}_{0} \\ {Y}_{0} \\ {Z}_{0} \\ {T}_{0} \\ {B}_{0}\end{matrix} ] + [ \begin{matrix}Δ X \\ Δ Y \\ Δ Z \\ Δ T \\ Δ B\end{matrix} ] \qquad ( 19 )$$

The aforementioned process is based around the assumption that the laser transmitter height and location are known. One benefit of a combined laser and GNSS system, is that it can be self-calibrating. Instead of solving for just the position of the detector antenna (plus clock and orientation nuisance parameters), it is possible to include the three dimensional position of the laser transmitter as an unknown, as well. As shown in FIG. 7, laser and GNSS position readings must be taken at more than two non-collinear points 90, 92 (i.e., two points that are not aligned) around the transmitter 94 to be able to compute the transmitter location. Preferably, many readings can be taken at a range of points surrounding the transmitter to be able to average out GNSS random errors and small systemic error sources. Where possible, the detector should be placed at points that establish roughly a 90 degree angle at the transmitter. This gives a good fix on the transmitter location.

GPS observations are normally made at regular time intervals or epochs. Laser readings are dictated by the rotation rate of the transmitter and therefore may not exactly coincide with the GPS observations. There are several ways of handling this situation, assuming that the movement of the receiver is rapid enough that an error may result from a lack of synchronization. First, the rotation rate of the laser transmitter may be increased so that a reading can be taken which is sufficiently close to a GPS epoch that negligible error in position results. Second, the motion of the rover can be modeled in a Kalman filter and the GPS and laser detector observations can be fed into the filter whenever they occur. Third, the rate of change of the GPS or laser observations can be modeled so that the observations can be skewed to a common epoch. In any case, the GPS and Laser observations can be readily processed together in a consistent manner.

Although the present invention has been described in terms of the presently preferred embodiments, it is to be understood that the disclosure is not to be interpreted as limiting. For example, the optical sensor and the GPS antenna are described as being mounted on the machine in one embodiment, and this is intended to include mounting these components on the body of the machine, or on the machine implement for movement therewith. Various alterations and modifications will no doubt become apparent to those skilled in the art after having read the above disclosure. Accordingly, it is intended that the appended claims be interpreted as covering all alterations and modifications as fall within the true spirit and scope of the invention.

What is claimed is:

1. A system for determining position, comprising
a laser transmitter that projects at least one laser beam that rotates about a generally vertical axis,
a GPS receiver for determining position, the GPS receiver having a GPS antenna,
an optical sensor for receiving the laser beam, said optical sensor being coaxial with, and at, or displaced a small distance from, the phase center of said GPS antenna, and
a device receiving signals from the GPS receiver and signals from the optical sensor to determine the position of the sensor and the receiver therefrom, said device utilizing signals received from the optical sensor to improve the estimate of position based on said signals from said GPS receiver.

2. The system of claim 1 in which said laser transmitter projects a pair of fan shaped beams of laser light, and in which the optical sensor is responsive to both of said beams.

3. The system of claim 1 in which said GPS antenna and said optical sensor are located on the same mast in close proximity.

4. The system of claim 1 in which a least squares approximation is utilized to determine the most likely position, based on the detection signals from the optical sensor and the GPS receiver.

5. A system for determining the position of a machine and controlling the machine, comprising
a laser transmitter, positioned at a reference position, that projects two or more fan-shaped laser beams and rotates the laser beams about a generally vertical axis, the two or more fan-shaped laser beams diverging in non-parallel, non-horizontal planes, with the line of intersection of these non-parallel, non-horizontal planes being non-vertical,
a GPS receiver on the machine for determining the position of the machine, the GPS receiver having a GPS antenna mounted on the machine,
an optical sensor mounted on a machine for receiving the fan-shaped laser beams, said optical sensor being coaxial with, and at, or displaced a small distance from, the phase center of said GPS antenna, and
a device on the machine, receiving a signal from the GPS receiver and a signal from the optical sensor, to determine the position of the machine from said signals and for providing a control signal.

6. The system of claim 5 in which said laser transmitter projects a pair of fan shaped beams of laser light, and in which the optical sensor is responsive to both of said beams for determining the position.

7. The system of claim 5 in which said GPS antenna and said optical sensor are located on the same mast in close proximity.

8. The system of claim 5 in which a least squares estimation process is utilized to determine the most likely position, based on the signals from the optical sensor and the GPS receiver.

9. A system for determining the position of a machine, comprising
a laser transmitter that projects two or more fan-shaped laser beams and rotates the laser beams about a generally vertical axis, the relative orientation of said two or more fan-shaped laser beams being maintained such that said beams diverge in a plane other than horizontal plane, with the fan-shaped laser beams differing in inclination angle with respect to the horizontal,
a GPS receiver on the machine for determining the position of the machine, the GPS receiver having a GPS antenna mounted on the machine,
an optical sensor mounted on the machine for receiving the fan-shaped laser beams, said optical sensor being coaxial with, and displaced a small distance from, the phase center of said GPS antenna, and
a device on the machine, receiving signals from the GPS receiver and signals from the optical sensor, to determine the position of the machine therefrom, said device utilizing said signals received from said optical sensor to facilitate the determination of said machine position based on said signals from said GPS receiver.

10. The system of claim 9 in which said laser transmitter projects a pair of fan shaped beams of laser light, and in which the optical sensor is responsive to both of said beams for determining the position.

11. The system of claim 9 in which said GPS antenna and said optical sensor are located on the same mast in close proximity.

12. The system of claim 9 in which a least squares approximation is utilized to determine the most likely position, based on the signals from the optical sensor and the GPS receiver.

13. The system of claim 9 in which said GPS antenna and said optical sensor are mounted on said machine in close, fixed proximity to each other, and in which said GPS antenna and said optical sensor are mounted for movement with an implement of said machine.

14. The system of claim 13 in which said device on the machine effects control of the position of said implement based on a sensed position and a desired position.

15. A system for determining the position of a machine and controlling the machine, comprising
a laser transmitter, positioned at a reference position, that projects two or more fan-shaped laser beams and rotates the laser beams about a generally vertical axis, the two or more fan-shaped laser beams diverging in non-parallel, non-horizontal planes, with the line of intersection of these non-parallel, non-horizontal planes being non-vertical,
a GPS receiver on the machine for determining the position of the machine, the GPS receiver having a GPS antenna mounted on the machine,
an optical sensor mounted on a machine for receiving the fan-shaped laser beams, said optical sensor being coaxial with, and displaced a small distance from, the phase center of said GPS antenna, and
a device on the machine, receiving a signal from the GPS receiver and a signal from the optical sensor, to determine the position of the machine from said signals and for providing a control signal.

16. The system of claim 15 in which said laser transmitter projects a pair of fan shaped beams of laser light, and in which the optical sensor is responsive to both of said beams for determining the position.

17. The system of claim 15 in which said GPS antenna and said optical sensor are located on the same mast in close proximity.

18. The system of claim 15 in which a least squares approximation is utilized to determine the most likely position, based on the detection signals from the optical sensor and the GPS receiver.

19. An improved position estimating system, comprising;
a global navigation satellite receiver including an antenna having a phase center, configured to provide first data for position estimation in response to reception of signals from a plurality of satellites,
at least one optical sensor with a known position relative to said antenna phase center, and configured to provide second data for position estimation, and
a microprocessor, responsive to said first data and said second data, configured to determine an estimate of the position of said receiver and said antenna.

20. The improved position estimation system of claim 19 in which said second data is combined with said first data before determination of said estimate of position.
